(19) United States
(12) Patent Application Publication
(10) Pub. No.: US 2009/0049108 A1
(43) Pub. Date: Feb. 19, 2009

(54) METHOD AND APPARATUS FOR WORKFLOW VERSIONING

(75) Inventors: Steve Forde, Ottawa (CA); Andrew Cheyne, Bedford (CA); Warren Gallagher, Richmond (CA); Adam Frankowski, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: GRIDIRON SOFTWARE INC., Ottawa (CA)

(21) Appl. No.: 12/175,225

(22) Filed: Jul. 17, 2008

Related U.S. Application Data
(60) Provisional application No. 60/950,159, filed on Jul. 17, 2007.

(51) Int. Cl. G06F 17/30; G06F 3/00

(52) U.S. Cl. 707/203; 715/855; 707/E17.005

(57) ABSTRACT

A method and system are provided for automatic workflow versioning. A workflow database can include metadata describing the relationships between data files, a workflow association and version/timestamp information such that relationships can be tracked against time and file versions. A system is provided to visualize a workflow and how it changes over time. A workflow navigator can be provided to allow a user to graphically “slide” back and forth in time between different workflow versions or points. Date/Time stamp information can be displayed and the workflow relationships and graphical thumbnails can change as the user hits dates/times where changes occurred. Further controls can be provided that allow the user to choose a previous version of a workflow from the timeline, and to bring forward in time the associated files and relationship information.

### CROSS REFERENCE TO RELATED APPLICATIONS

This application claims the benefit of priority of U.S. Provisional Patent Application No. 60/950,159 filed Jul. 17, 2007, which is incorporated herein by reference in its entirety.

This application is related to the following applications: U.S. Provisional Patent Application No. 60/950,155 filed on Jul. 17, 2007 and entitled “Automatic File Versioning”; U.S. Provisional Patent Application No. 60/950,158 filed on Jul. 17, 2007 and entitled “Indexing Through File Format Understanding”; U.S. Provisional Patent Application No. 60/950,166 filed on Jul. 17, 2007 and entitled “File Browser for Computing Environment”; U.S. application Ser. No. ______ (Attorney Docket No.: PAT 4297-2) entitled “Asset Browser for Computing Environment” and filed of even date herewith; and U.S. application Ser. No. ______ (Attorney Docket No.: PAT 4294-2) entitled “Automatic File Versioning” and filed of even date herewith.

### FIELD OF THE INVENTION

The present invention relates generally to computing environments. More particularly, the present invention relates to the display of relationships between data files.

### BACKGROUND OF THE INVENTION

Computing environments enable users to create and modify documents and other files using a number of application programs, often simply referred to as programs or applications. Desktop and other computing environments include an operating system, which enables a user to store and organize files in different folders. Most operating systems provide a number of different manners in which to view files and folders, such as in a tree view. These views only show relationships between files and folders in terms of how the files or documents are stored hierarchically on the computer, or other storage media.

In many instances, a user creates a number of different documents that are stored in different locations, or created by different applications, yet are related to one another. Moreover, it has now become common for a number of different users to collaborate on a particular project and create a number of different files in the process of undertaking that project. Workflow can change over time as users add data files to a project and make changes to existing files. Desktop computing environments are not equipped to determine and display relationships between documents or data files, creating a deficiency in these systems.

This deficiency is particularly evident in video production, web publishing and desktop publishing. In video production it is not unusual for a user to use 10 different application tools, creating hundreds of files. For instance:

still raster graphics may be done by importing photographs into Adobe Photoshop,

still vector graphics may be created in Adobe Illustrator

motion graphics may be done in Adobe After Effects after having imported Photoshop and Illustrator files. The After Effects project may be used to generate two movie files, one with time codes embedded and one without.

The movie with time codes may be imported into ProTools to do sound design. The ProTools project may generate audio files.

The audio files and movie without time codes may be imported into Final Cut Pro for video editing. The output from Final Cut Pro might be a movie with both audio and video.

The movie output from Final Cut might be imported into Compressor to do encoding to a compressed format for distribution on the web and DVD.

Most video production workflows are much more complex than the description provided above. Additionally, the process followed to achieve the end results often involves much iteration or editing of existing files. Most users have very few ways of understanding their workflow. All of this understanding is typically left in the user's head, as is the information relating to data file relationships and workflow relationships.

A fundamental capability is missing from today's desktop computing environments. That is the ability to automatically determine and visualize workflow relationships.

While version history and metadata can be viewed in known approaches, it is generally not automatically generated independent of user interaction. Known approaches only provide version information and metadata associated with individual documents or assets in accordance with schemes developed for those file formats or the application with which they have been created or modified. There is a need to provide version information that can be applied to an entire workflow, even when the workflow includes documents, files and assets that differ from one another in format and associated application.

It is, therefore, desirable to provide an approach that overcomes drawbacks of existing mechanisms.

### SUMMARY OF THE INVENTION

It is an object of the present invention to obviate or mitigate at least one disadvantage of previous workflow versioning approaches.

In an aspect, the present invention provides a method of automatic workflow versioning including the following steps: detecting a workflow versioning event for a selected asset stored in memory in a computing environment, the selected asset being part of a set of assets associated with a workflow; augmenting a workflow database with a new workflow version in response to the detected workflow versioning event; updating a visual representation of the selected asset in a workflow map based on the new workflow version, the workflow map including the set of assets; and displaying an updated workflow map of the set of assets, the updated workflow map including the updated visual representation of the selected asset.

In an embodiment, augmenting the workflow database can include adding a new workflow version entry to an existing database entry for the selected asset based on information associated with the detected workflow versioning event. Detecting the workflow versioning event can include extracting updated logical relationship information for the selected asset, in which case augmenting the workflow database can include adding a new workflow version entry to an existing database entry for the selected asset based on the extracted updated logical relationship information.

Augmenting the workflow database can alternatively include adding a database entry for the new workflow version, the database entry including an identification of the set of assets and their logical relationships at the time of the new workflow version. The method can further include associating the asset with the workflow when the workflow versioning event is the first workflow versioning event for the asset as part of the workflow.

In another aspect, the present invention provides a computer-readable medium storing statements and instructions which, when executed, cause a processor to perform the steps of a method of automatic workflow versioning as described above.

In a further aspect, the present invention provides a system for automatic workflow versioning including a workflow database, a workflow versioning event detector, a workflow version creator and a workflow mapper. The workflow database stores a workflow association associating a set of assets stored in memory in a computing environment with a workflow. The workflow versioning event detector detects a workflow versioning event for a selected asset from the set of assets. The workflow version creator is in communication with the workflow versioning detector and creates a new workflow version in response to detection of the workflow versioning event. The workflow version creator also augments the workflow database based on the detected workflow versioning event. The workflow mapper updates a visual representation of the selected asset in a workflow map based on the updated database. The workflow mapper also displays an updated workflow map of the set of assets. The updated workflow map includes the updated visual representation of the selected asset.

The system can further include a relationship extractor, in communication with the workflow database, to extract logical relationship information for the set of assets. The relationship extractor can further include a file format detector to detect a file format of a selected asset. In that case, the relationship extractor can extract logical relationship attributes associated with the detected file format.

The relationship extractor can further include a file system event tracker to extract relationship information from a kernel extension in response to detection of a file system event that involves two different assets. The file system event can be: a copy action; a paste action; a save as action; a file move action; a file rename action; a file link action; a file delete action; a file open action; or a file close action. The workflow database can associate the set of assets as part of the workflow even in the absence of a logical relationship between the set of assets.

The workflow mapper can display a workflow map navigator including a navigation control to permit a user to navigate between workflow versions on a workflow timeline. In response to navigation of the navigation control to a previous position on the workflow timeline, the workflow mapper can display a previous workflow map for the previous position. The previous workflow map displays a subset of the plurality of assets having an earlier workflow association with one another at the previous position on the workflow timeline.

The workflow mapper can display an activity indicator associated with the workflow timeline to visually indicate an amount of workflow activity associated with a particular portion of the timeline. The workflow mapper can also display a version indicator associated with the timeline to visually indicate a time or version number associated with a particular version of the workflow. The workflow database, the workflow versioning event detector, the workflow version creator and the workflow mapper can be provided independent of an application in which assets are generated.

In a yet further aspect, the present invention provides a graphical user interface providing an ordered display of assets stored in memory in a computing system, the assets being part of a workflow. The GUI includes a workflow map displaying a plurality of assets having a workflow association with one another at a particular time. The workflow association associates the plurality of assets as part of the workflow even in the absence of a logical relationship between the plurality of assets. The workflow map concurrently displays a visual indication of a logical relationship between a first asset and a second asset at the particular time. The first and second assets are part of the plurality of assets.

The workflow map can further concurrently display an additional logical workflow relationship between related assets in the plurality of assets. The additional logical workflow relationship is distinct from the logical workflow relationship. The workflow association can associate the plurality of assets as part of the workflow even in the absence of a logical usage relationship between the plurality of assets.

The GUI can further include a workflow map navigator including a workflow timeline. The workflow map navigator indicates a position on the workflow timeline of a workflow version for which the workflow map is being displayed.

The workflow map navigator can be movable to a previous position on the workflow timeline. In response to such movement, the GUI displays a previous workflow map for the previous position. The previous workflow map displays a subset of the plurality of assets having an earlier workflow association with one another at the previous position on the workflow timeline.

The previous workflow map can concurrently display a further visual indication of a logical workflow relationship between a third asset and a fourth asset at the particular time. The first and second assets are part of the subset of the plurality of assets. The workflow map navigator can further include: an activity indicator associated with the timeline to visually indicate an amount of workflow activity associated with a particular portion of the timeline; and/or a version indicator associated with the timeline to visually indicate a time associated with a particular version of the workflow.

In a still further aspect, the present invention provides a GUI providing an ordered display of assets stored in memory in a computing system, the assets being part of a workflow. The GUI includes a workflow map displaying a plurality of assets having a workflow association with one another at a particular time. The workflow association associates the plurality of assets as part of the workflow even in the absence of a logical relationship between the plurality of assets.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flowchart illustrating a method of automatic workflow versioning according to an embodiment of the present invention;

FIGS. 2-7 illustrate workflow maps according to an embodiment of the present invention at times t₁ to t₆, respectively;

FIG. 8 illustrates a block diagram of a system for automatic workflow versioning according to an embodiment of the present invention;

FIG. 9 illustrates a block diagram of an apparatus, or system, for automatic workflow versioning according to an embodiment of the present invention;

FIG. 10 illustrates a network diagram including a plurality of entities according to an embodiment of the present invention;

FIG. 11 illustrates a block diagram of a workflow versioning client design according to an embodiment of the present invention;

FIG. 12 illustrates an exemplary output of a parser according to an embodiment of the present invention showing relationship information extracted based on file format understanding;

FIG. 13 illustrates a first portion of a workflow database schema according to an embodiment of the present invention;

FIG. 14 is a flowchart illustrating steps in a method of adding a new node or node version according to an embodiment of the present invention;

FIG. 15 illustrates a second portion of a workflow database schema according to an embodiment of the present invention;

FIG. 16 is a flowchart illustrating steps in a method of adding a new link according to an embodiment of the present invention;

FIG. 17 illustrates a third portion of a workflow database schema according to an embodiment of the present invention; and

FIG. 18 is a flowchart illustrating steps in a method of up-versioning a graph or workflow map according to an embodiment of the present invention when new node versions are added to a new or existing graph.

### DETAILED DESCRIPTION

Generally, the present invention provides a method and system for automatic workflow versioning. A workflow database can include metadata describing the relationships between data files, a workflow association and version/timestamp information such that relationships can be tracked against time and file versions. A system is provided to visualize a workflow and how it changes over time. A workflow navigator can be provided to allow a user to graphically “slide” back and forth in time between different workflow versions or points. Date/Time stamp information can be displayed and the workflow relationships and graphical thumbnails can change as the user hits dates/times where changes occurred. Further controls can be provided that allow the user to choose a previous version of a workflow from the timeline, and to bring forward in time the associated files and relationship information.

The ability to automatically version data files is a foundation upon which embodiments of the present invention build. A method to automatically version data files is described in U.S. Provisional Patent Application No. 60/950,155 filed on Jul. 17, 2007 and entitled “Automatic File Versioning”, which is incorporated herein by reference.

Embodiments of the present invention can automatically create a database of metadata describing the relationships between data files. The database can be extended to include version/timestamp information such that relationships can be tracked against time and file versions. A means of visualizing a workflow and how it changes over time is also provided.

Embodiments of the present invention provide a workflow map as a means for displaying all assets or files relating to a particular workflow, so that they can be visualized. A workflow as referred to herein represents a set of assets, relationships and actions involved in accomplishing a work or project over a period of time. The workflow map can indicate logical relationships between the assets, which can be based on actions, and also the people or objects taking the actions. The workflow map changes over time depending on when and how assets are involved in the workflow, such as a project. In an embodiment, a user can scroll back in time to view the workflow state at a particular time.

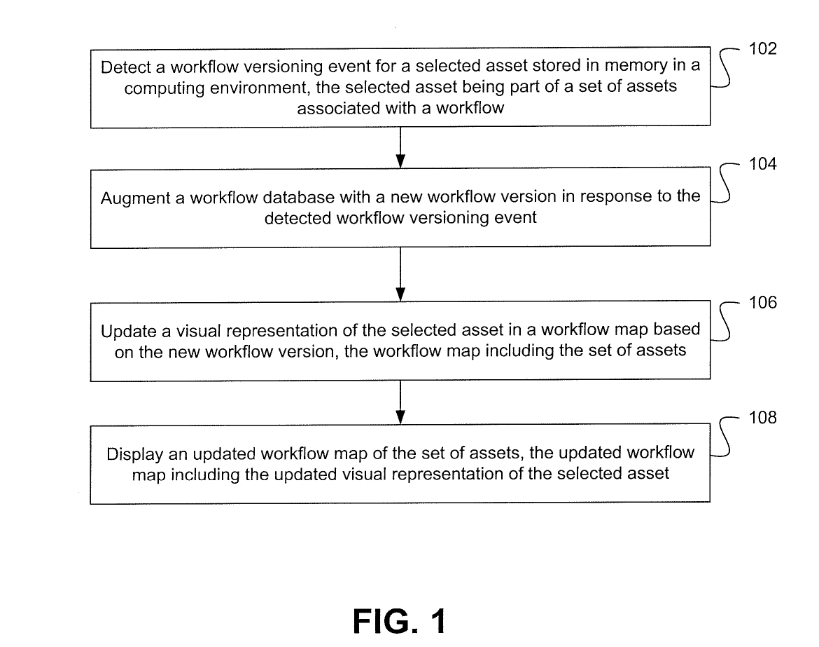

FIG. 1 is a flowchart illustrating steps in a method of automatic workflow versioning according to an embodiment of the present invention. In a first step 102, a workflow versioning event is detected for a selected asset stored in memory in a computing environment. The selected asset is part of a set of assets associated with a workflow. The computing environment can include one or more local, remote or networked computers or computing systems. In step 104, a workflow database is augmented with a new workflow version in response to detection of the workflow versioning event. The new workflow version can be identified by a timestamp, a version number, or by any other suitable identifier, or combination of identifiers.

Augmenting the workflow database can include adding a new workflow version entry to an existing database entry for the selected asset based on information associated with the detected workflow versioning event, such as extracted updated logical relationship information. Alternatively, the step of augmenting the workflow database can include adding a database entry for the new workflow version, the database entry including an identification of the set of assets and their logical relationships at the time of the new workflow version. Embodiments of the present invention can include other variations or combinations of adding information to a workflow database to augment it to include information based on the new workflow version. The database entry can be in a workflow database.

In step 106, a visual representation of the selected asset is updated in a workflow map based on the new workflow version. The workflow map includes the set of assets. The updated visual representation in step 106 can be stored in a display memory in the computing environment, such as in a workflow mapper. In step 108, an updated workflow map of the set of assets is displayed. The updated workflow map includes the updated visual representation of the selected asset.

When the workflow versioning event is the first workflow versioning event for the selected asset as part of the workflow, the selected asset can be associated with the workflow at that point. Updating the workflow map can comprise updating only a portion of the workflow map relating to the asset.

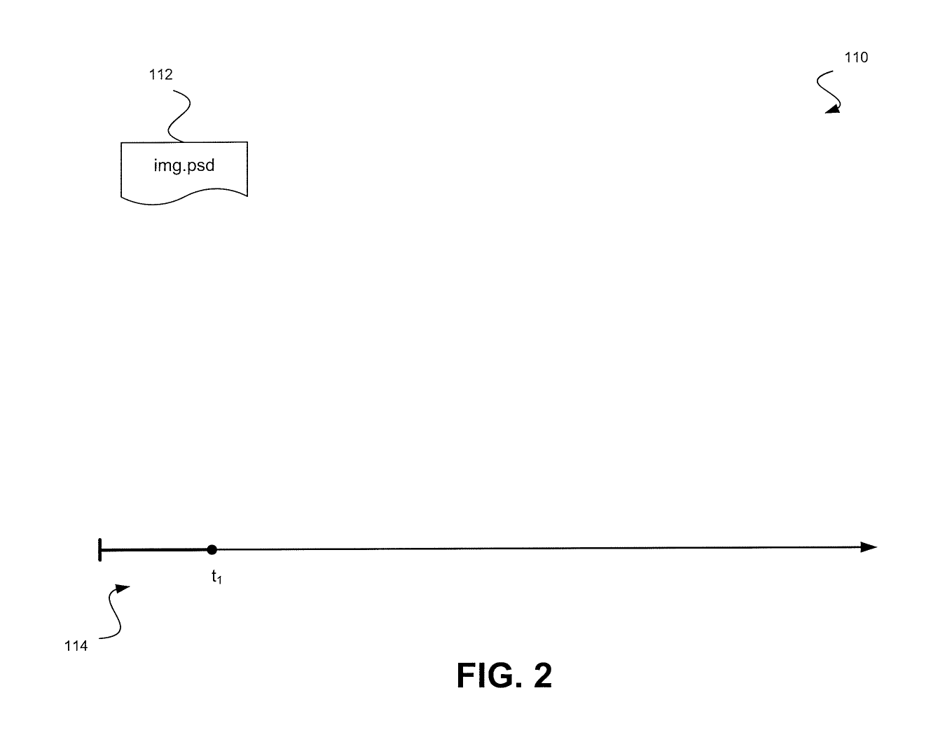

FIGS. 2 to 7 illustrate project workflow maps according to an embodiment of the present invention. In this example, the project is an Adobe After Effects project, though workflow for any type of project can be modeled. The project does not need to have an actual project file, and may simply be a task or project that a user has been asked to work on. In the example discussed herein, an After Effects project file named ProjectA.aep has a bin in which external files are referenced. A composition can use zero or more assets in the bin. Each composition can be rendered out to an end product, such as a movie file.

FIG. 2 illustrates a workflow map 110 displaying the state of a workflow at time t₁ when an image file 112 named img.psd is created or accessed. The creation of the image file is an exemplary workflow versioning event that can be detected to create a new workflow version. At time t₁, a workflow database is augmented to associate the image file 112 with the workflow.

A workflow map navigator, or workflow map slider, 114 is shown at the bottom of FIG. 2 and indicates a position on a workflow timeline for which the workflow map is being displayed. The scale of the workflow timeline can be modified to suit the application, and extends until the last or current time in the workflow project. The default visualization shown can be the most current for the displayed data set, and the slider or navigator 114 can be initially positioned to the extreme right of the slider control indicating the current time. The user can “scrub” over the timeline by moving the slider “back in time”. Date/Time stamp information can be displayed and the workflow relationships and graphical thumbnails can change as the user hits dates/times where changes occurred.

A blank workflow map (not shown) can be displayed at time to, or the beginning of the workflow. According to an embodiment of the present invention, for a workflow map to truly represent all assets and relationships involved in a workflow, the map is created or initiated as a blank canvas at the outset of the workflow, before the first workflow versioning event in the workflow. That way, everything that happens in relation to the workflow can be captured, stored and visualized.

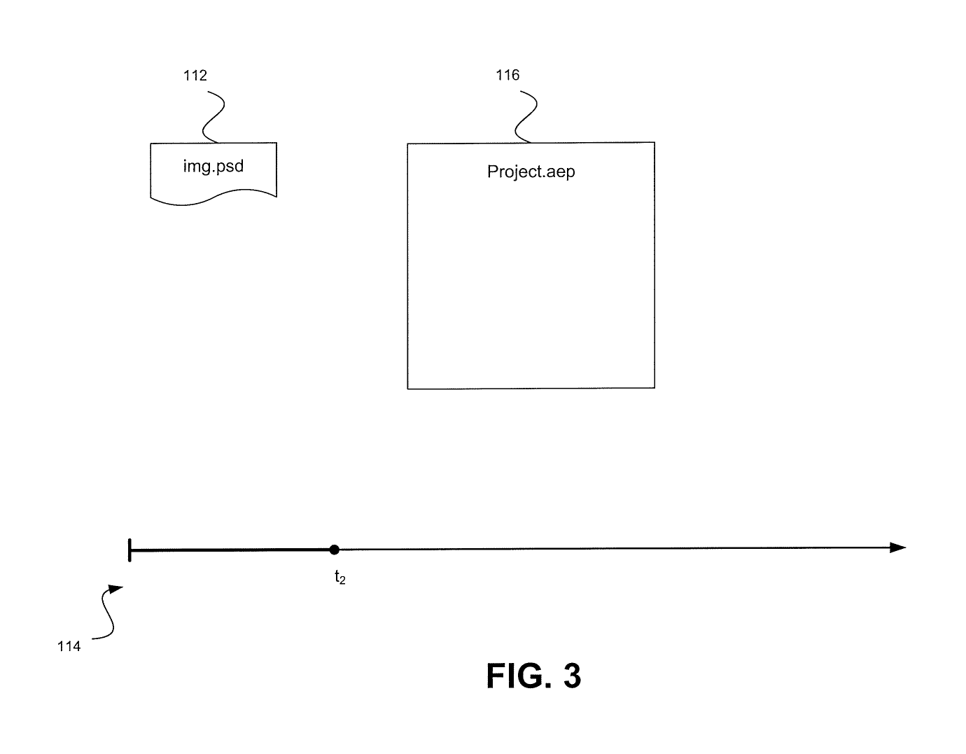

FIG. 3 illustrates a workflow map at time t₂, where a project file 116 named ProjectA.aep is created. This workflow versioning event is detected, and a new workflow versioning event is created. A workflow database is augmented to include a workflow association for the two assets 112 and 116. While there is no formal logical relationship association between the files 112 and 116 at time t₂, they are both included as part of the workflow for this particular project at this time. The two files can be added by the same user, or by different users collaborating in the workflow. In known approaches, at time t₂ these two files would have no metadata relating one to the other, since no action has yet happened linking the two assets.

According to an embodiment of the present invention, assets are inherently assigned a workflow association with each other at the time that they are both part of the same workflow, or workflow map. The workflow association is a type of asset association that is separate from a logical relationship between assets. Assets can have a workflow association with one another as part of a set of assets associated with the same workflow, even in the absence of a logical relationship between the set of assets. Workflow association and logical relationship information can be stored in the workflow database as part of an entry associated with each asset in a set of assets in the workflow.

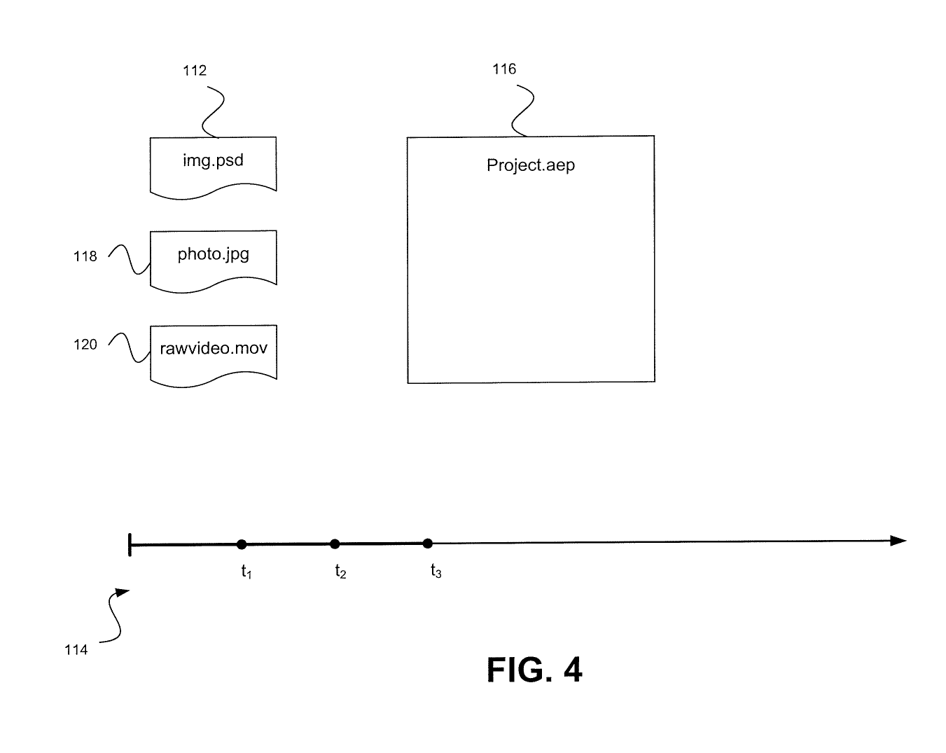

FIG. 4 illustrates a workflow map at time t₃, where further assets 118 (photo.jpg) and 120 (rawvideo.mov) are added to the workflow. Again, though these assets have no formal logical relationship with each other or with any other files, the workflow database is augmented to associate the assets 118 and 120 with the workflow. By virtue of the workflow association, the assets shown in FIG. 4 also have an association with each other in the workflow at time t₃, the workflow association being distinct from a logical relationship between the assets.

As shown in FIG. 4, the workflow timeline can display previous workflow version information. In this case, the workflow timeline displays all previous time entries for which a new workflow version has been created and saved. In an embodiment, the workflow version information can be displayed as a workflow version number, a date/time stamp, or any other suitable version indicator, or combination thereof.

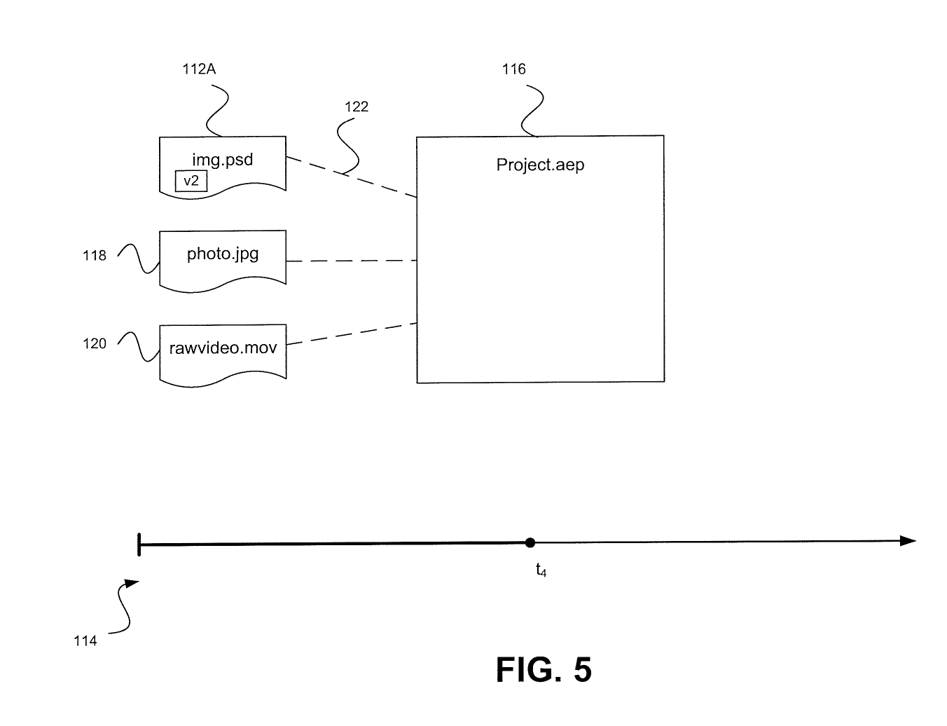

FIG. 5 illustrates a workflow map at time t₄, where two workflow versioning events have taken place. The first workflow versioning event is that the asset img.psd has been modified and has been saved as new version, represented in FIG. 5 as 112A. This asset versioning event is detected as a workflow versioning event. In this embodiment, a visual indication is provided to indicate that 112A is the second version of that asset. In another embodiment, this version information can be hidden or partially hidden from the user in this view, and can optionally be made available by selecting the asset and requesting details or further information.

The second workflow versioning event represented in FIG. 5 is that the assets 112A, 118 and 120 are added to project file 116. The dashed lines 122 between those added files and the ProjectA.aep file indicate that the files have been added to the bin for ProjectA.aep, in which those external files can be referenced. The dashed lines visually indicate the logical relationship that the assets 112A, 118 and 120 are used, or available for use, by the project 116.

At time t₄, the workflow database is updated with a new workflow version identifier, including new workflow versioning information obtained based on the detected workflow versioning event. Each asset associated with the workflow at time t₄ can be assigned the new workflow version identifier. As such, at time t4, the workflow database includes workflow association and logical relationship information for assets 112A, 118, 120 and 116. The workflow database also includes workflow version information, and can include asset version information.

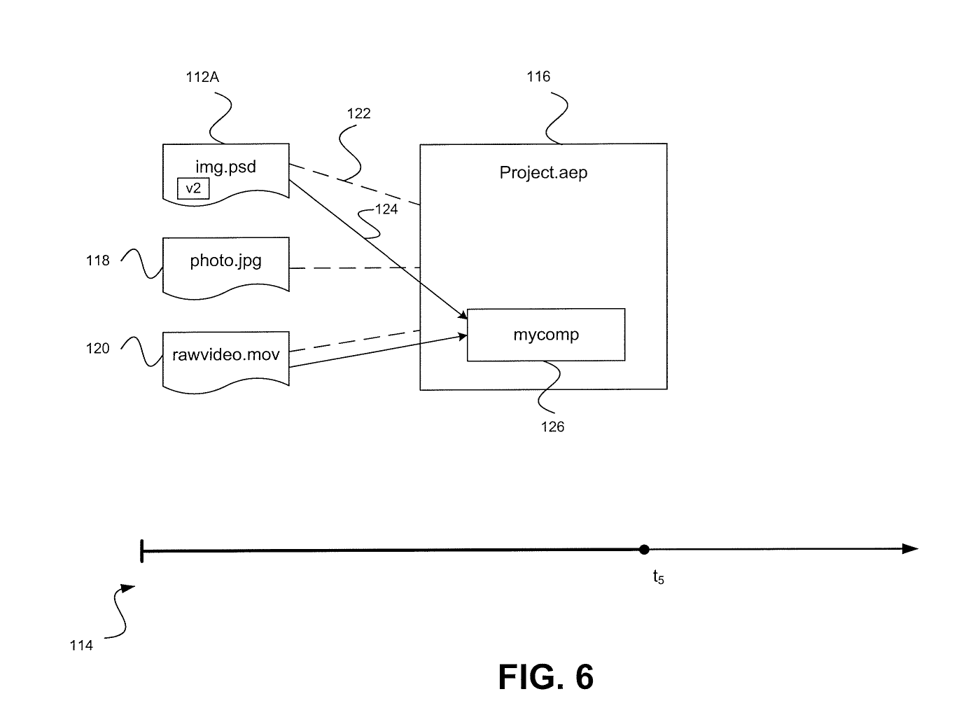

FIG. 6 illustrates a workflow map at time t₅, at which time a composition 126 entitled mycomp is created using the img.psd and rawvideo.mov assets. The solid lines 124 represent the use of those files in the composition. For example, the arrows on the solid lines 124 indicate that the composition 126 contains the assets 112A and 120. While the dashed lines 122 are still shown in FIG. 6, in an alternative embodiment, the dashed lines can be removed, and only the lines representing files used in the composition can be displayed. According to an embodiment of the present invention, different visual indications can be used to distinguish between similar logical relationship types, such as “used by”, “available for use by” and “contained in”, and/or between dissimilar logical relationship types.

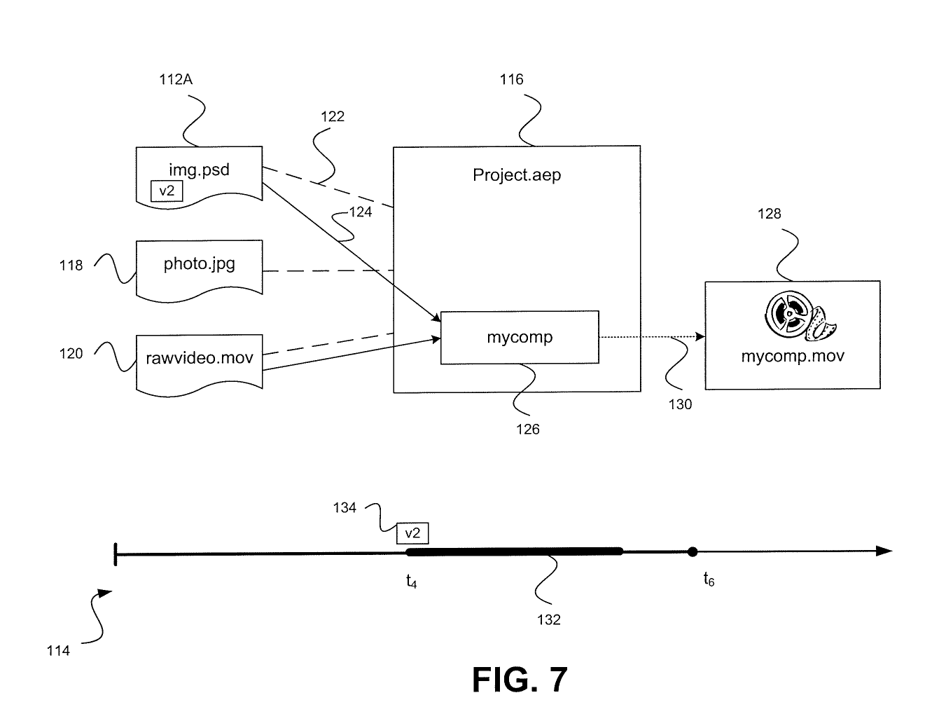

FIG. 7 illustrates the workflow map at time t₆ at which the composition 126 is rendered to an output file 128 entitled mycomp.mov. As indicated by the dotted line 130 ending in an arrow, the composition 126 generates the output file 128. While arrows are used at the end of the line types to facilitate understanding of generation and containment, they are not required. In other embodiments, one or more of different line types, line widths, line colours, shapes, etc can represent different relationship types, and enable a user to distinguish between them.

The workflow map navigator 114 can be used to slide back and forth in time on a workflow timeline within a workflow map. As a user drags back, blocks and lines representing assets and their relationships disappear at appropriate times. For example, if a user viewing the workflow map at time t₆ in FIG. 7 moves the navigator 114 back to time t₃, the workflow map of FIG. 4 is displayed.

In an embodiment, further controls (not shown) are provided that allow the user to choose a previous version of a workflow from the timeline. When this occurs, the file versions and relationship information for those file versions are “brought forward” in time and can be made the most current.

As shown in FIG. 7 where an indicator for time t₄ is seen, some or all of previous time indicators can be displayed. In an embodiment, previous time or version indicators are selectively shown when a workflow event of interest has occurred at that time. This determination can be made based on a comparison of the detected workflow event at that workflow time/version with a workflow event filter. Alternatively, previous time or version indicators can be selectively displayed based on an amount of workflow events in a time period, as compared with a threshold of workflow events.

Other visual indicators can be provided on or around the workflow timeline. For example, a “heat map” indicating times of intense user activity can be provided on the timeline as a further visual cue. This heat map can be represented as an activity indicator 132 on the workflow timeline. The activity indicator 132 can vary in size, colour, shade and/or intensity (or any other suitable means of indication) to visually indicate the amount of activity at a given time, or in a given range of time. The determination of whether to provide an activity indicator can be based on comparison of a detected amount of workflow versioning events with a stored workflow activity threshold. Version information can also be provided on the timeline itself, such as using a version indicator 134. In this example, the version indicator indicates a version of a particular asset in the workflow, which can correspond to a version of the entire workflow at that time. Alternatively, workflow versions can be indicated separately from other asset versions. A user can slide back in time in relation to a desired time and/or a desired workflow or asset version.

The workflow map illustrates how the workflow and relationships of different files and assets change over time. It can illustrate everything that has been done in relation to a workflow or project, and it is all done automatically without the need for a user to be involved in providing information.

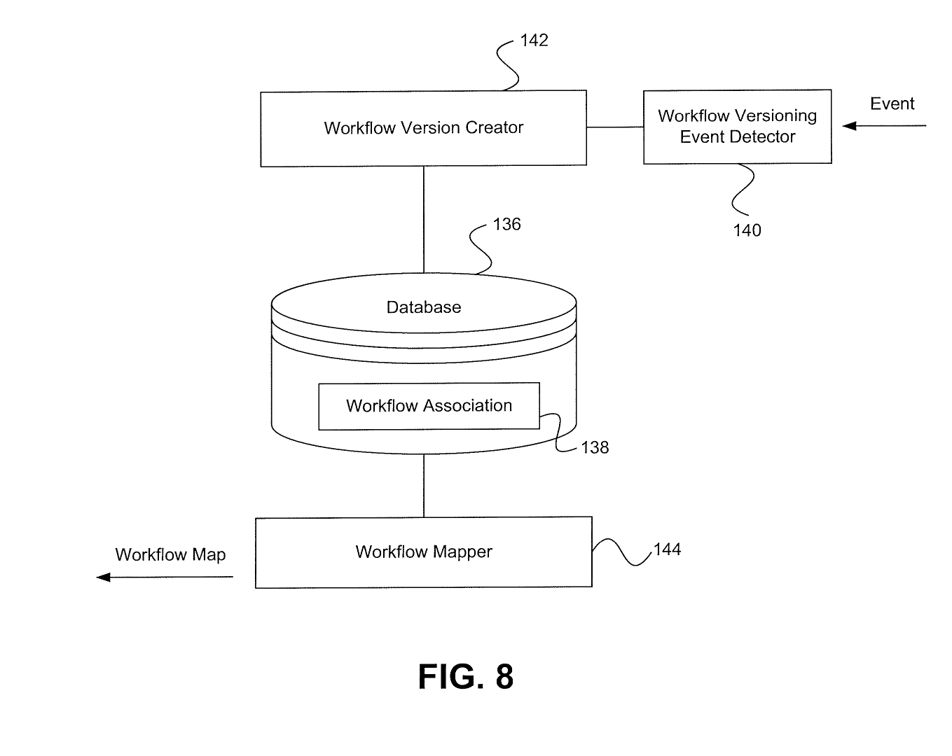

FIG. 8 illustrates a block diagram of an apparatus, or system, for automatic workflow versioning according to an embodiment of the present invention. A workflow database 136 stores a workflow association 138 associating a set of assets stored in memory in a computing environment with a workflow. The workflow association can be a tag, field or entry associated with an asset's entry in the workflow database. For example, each asset in a set of assets associated with workflow AA can have a value of AA in a workflow association field. Alternatively, the workflow association can be provided in a workflow version's entry in the workflow database and associated with each asset involved in the workflow at the time of that version.

A workflow versioning event detector 140 detects a workflow versioning event for a selected asset from the set of assets. This ensures that a new workflow version can be created each time a workflow versioning event occurs in relation to an asset belonging to a set of assets in the workflow. A workflow version creator 142 is in communication with the workflow versioning detector 140 to create a new workflow version in response to detection of the workflow versioning event. The workflow version creator 142 also augments the database based on the detected workflow versioning event.

A workflow mapper 144 is provided to update a visual representation of the selected asset in a workflow map based on the updated database. The workflow mapper also displays an updated workflow map of the set of assets. The updated workflow map includes the updated visual representation of the selected asset. Examples of the display of updated workflow maps have been discussed in relation to FIGS. 2-7.

In some cases, it may be desirable to only create a new workflow version or display a new workflow map under certain conditions. The workflow version creator 142 can optionally include a workflow event filter to enable the selective creation a new workflow version in response to a determination that the detected workflow event meets a workflow version creation criterion. The workflow version creator can then create a new workflow version and augment the database in response to determination that the detected workflow versioning event passed through the workflow event filter. Similarly, the workflow mapper 144 can optionally include a workflow mapping filter to enable the selective display of a portion of a workflow map in response to a determination that a visual representation of a selected asset meets a workflow map display criterion.

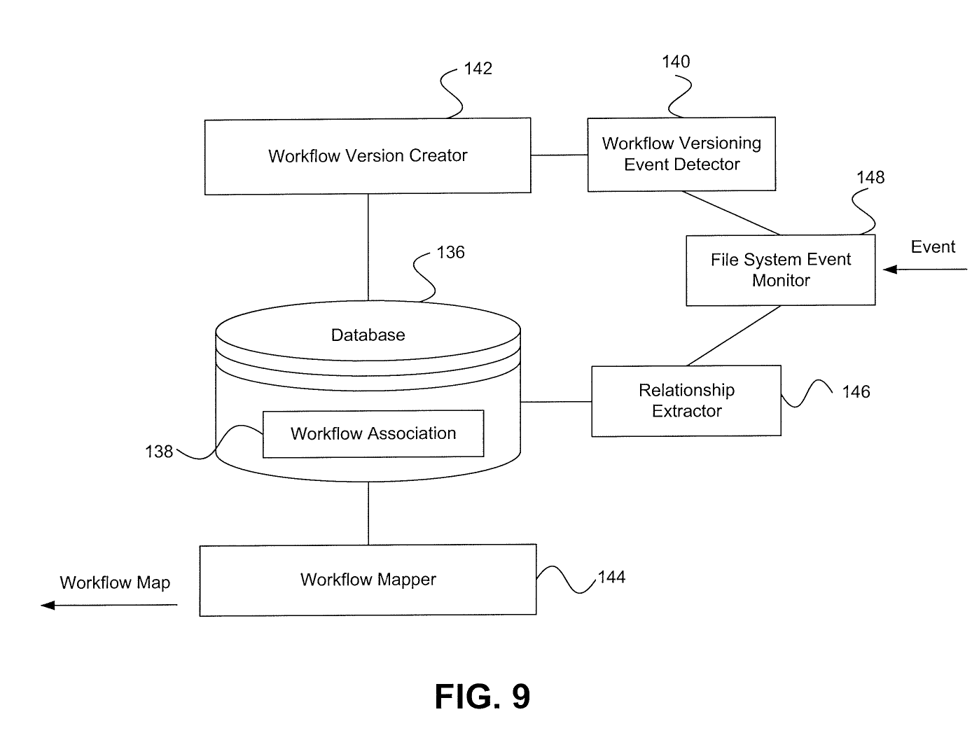

FIG. 9 illustrates a block diagram of an apparatus, or system, for automatic workflow versioning according to an embodiment of the present invention. The embodiment in FIG. 9 is similar to the embodiment in FIG. 8, and further includes a relationship extractor 146 to automatically determine workflow relationships between data files. The relationship extractor 146 can determine or extract information in response to a detected file system event and/or can extract relationship information from the file itself.

To extract relationship information, it is desirable to be able to identify when a file system event occurs. When files or versions of files are written to disk, there is often a set of steps involving writing temporary files, deleting and/or renaming another file. Such steps and sequences of steps are known to one of ordinary skill in the art. Fortunately, modern operating systems such as Linux, Microsoft Windows and Apple OS X allow the creation and of operating system kernel extensions that can provide information such as: a file operation is occurring; what user id is causing the file system operation; what application process is requesting the file system operation; what the file system operation is; what file path(s) the operation is being performed on. Typical operations are: File Open; File Close unmodified; File Close modified; File Delete; File Rename; and File Link. Embodiments of the present invention utilize a kernel extension that notifies a user-space program of these file system events.

As shown in FIG. 9, a file system event monitor 148 can be provided as a user space program that receives these notifications from kernel space and reacts to certain events to accomplish automatic, transparent reading of new/modified application data files and/or extraction of relationship information based on file system operation information contained in the kernel extension. As such, the file system event monitor 148 is in communication with the workflow versioning event detector 140 and the relationship extractor 146.

The relationship extractor 148 can extract relationship information by tracking or monitoring file system events. In an embodiment, the relationship extractor 148 can extract relationship information by tracking copy/paste activity through the clipboard. For example, suppose a portion of an Adobe Illustrator file somefile.ai is copied to the clipboard and pasted into anotherfile.ai, or even into yetanotherfile.doc. Embodiments of the present invention can create a dependent relationship between anotherfile.ai (and/or yetanotherfile.doc) with somefile.ai.

In a further embodiment, the relationship extractor 148 can extract relationship information by tracking Save As operations. For example, suppose the file img.psd is saved as blue.psd, which is then a derivative of img.psd. Embodiments of the present invention can create a dependent relationship between blue.psd and img.psd.

In a yet further embodiment, the relationship extractor 148 can extract relationship information by tracking Export operations. For example, suppose the file img.psd is exported to a Portable Document Format file img.pdf. Embodiments of the present invention can crate a dependent relationship between img.pdf and img.psd.

In a still further embodiment, the relationship extractor 148 can extract relationship information by tracking file move operations, where a file is moved from one place to another in the file system.

As mentioned earlier, the relationship extractor 146 can automatically determine workflow relationships between data files. Embodiments of the present invention can make such relationship determinations without having to modify the application tools users utilize, and without requiring the user to change the way they use their computers and application tools. A means for automatically determining workflow relationships between data files is described in U.S. Provisional Patent Application No. 60/950,158 filed on Jul. 17, 2007 and entitled “Indexing Through File Format Understanding”, which is incorporated herein by reference.

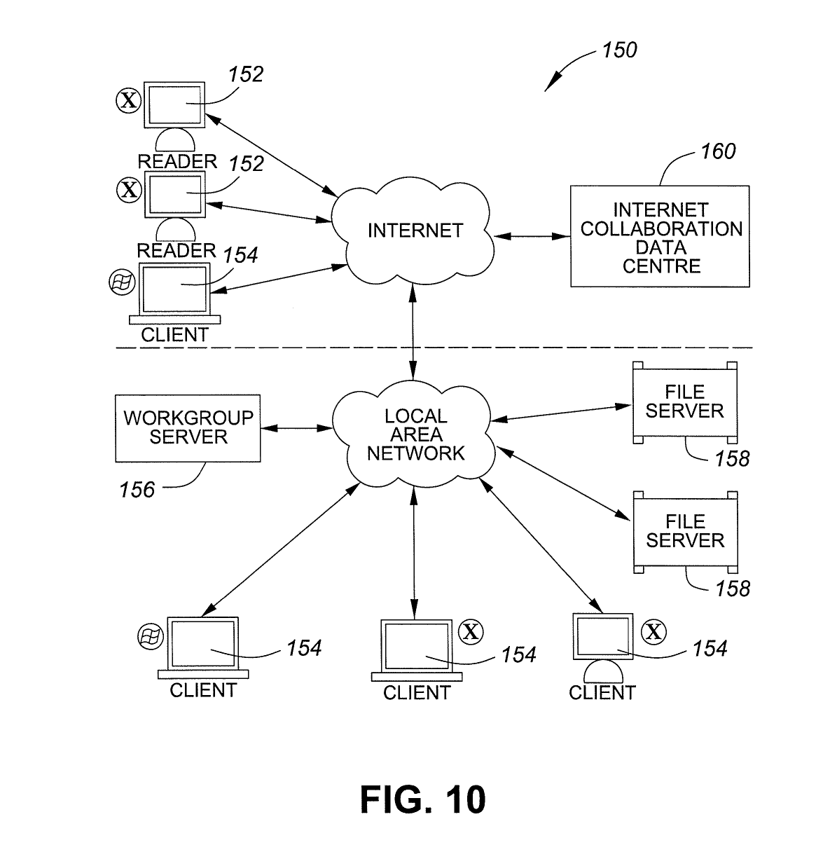

FIG. 10 illustrates a network diagram 150 including a plurality of entities according to an embodiment of the present invention. Embodiments of the present invention can be provided as part of a suite of components including a reader 152, a client 154, a workgroup server 156, a file server 158, and an internet collaboration server 160. The reader 152 can be provided as a free web application that allows read-only use of asset maps via the internet collaboration server 160. The client 154 can be provided as full desktop client software for Mac and Windows that supports automatic creation of asset maps, automatic file versioning, automatic workflow versioning, and automatic time tracking. The client supports interaction with the file server 158 for automatic versioning of networked assets, and supports interaction with the workgroup server 156 for distributed asset map tracking and time tracking.

The workgroup server 156 comprises server software running on Mac or Windows that supports tracking or distributed asset maps and distributed time tracking. The workgroup server works in conjunction with the client software 154 to accomplish this task. The file server 158 comprises server software capable of running on Mac, Windows and Linux that supports automatic file versioning for network volumes exported via AppleTalk Filing Protocol (AFP), server message block (SMB), or network file system (NFS). The file server works in conjunction with the client software 154 to accomplish this facility. Finally, the internet collaboration server 160 comprises an internet hosted web application that provides the capabilities required for asset maps to be shared between desktop clients and non-users.

While the reader 152, the client 154, the workgroup server 156, the file server 158, and the internet collaboration server 160 are shown as independent entities, they can be provided as software or firmware that is stored in memory on an existing device.

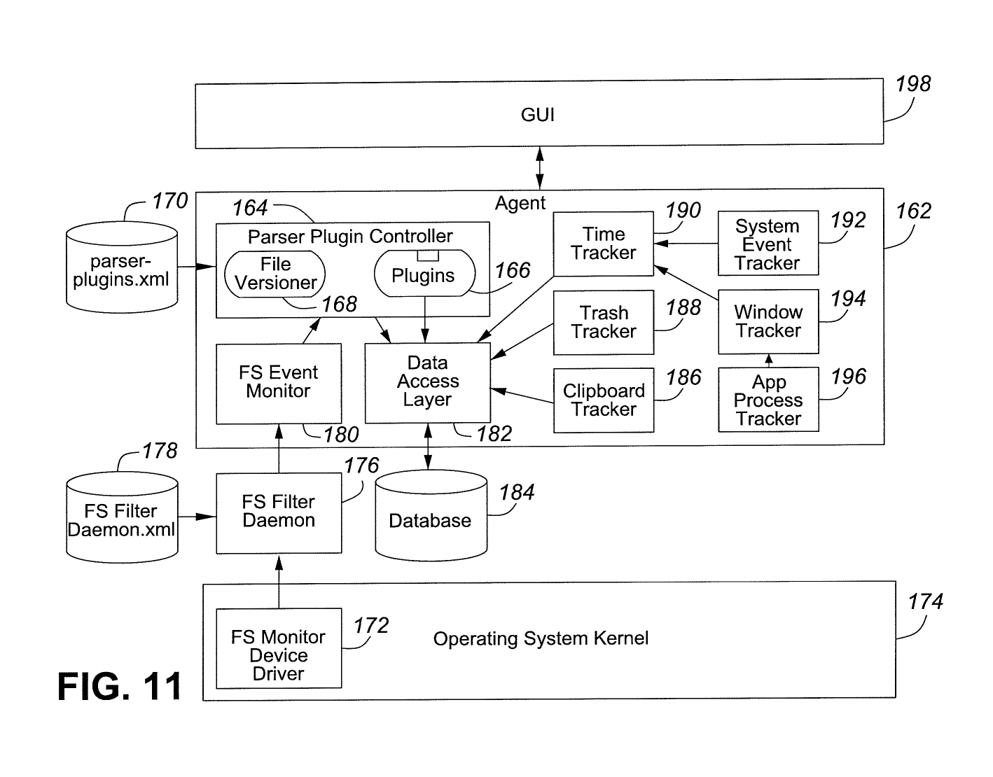

FIG. 11 illustrates a block diagram of a workflow versioning client design according to an embodiment of the present invention. This block diagram shows various elements that can be provided in a client 154, such as in relation to the system described in relation to FIG. 10. As illustrated in FIG. 11, an asset browser agent, or workflow versioning client, 162 can include a parser plugin controller 164, which itself can include plugins 166 and an asset versioner, such as a file versioner 168. The file versioner 168 can receive file relationship information from parser plugins 166, which it interprets according to the definitions provided by the parser-plugins.xml file 170. A file system monitor device driver 172 can be provided in an operating system kernel 174. The file system (FS) monitor device driver 172 can communicate with a file system filter daemon 176 that filters file system events detected by the FS monitor device driver according to a set of versioning events stored in an FS filter daemon.xml file 178.

A file system event monitor 180 in the asset browser agent 162 is in communication with the file system filter daemon 176 and the parser plugin controller 164. A data access layer 182 is also provided in communication with the parser plugin controller 164 and a workflow database 184, similar to the workflow database described earlier. A clipboard tracker 186, a trash tracker 188, and a time tracker 190 are in communication with the data access layer 182. A system event tracker 192 and a window tracker 194, which itself receives information from an application process tracker 196, are both in communication with the time tracker 190. These elements can co-operate to provide a system as described earlier, including at least some of the various functions described above and in the related applications referred to earlier. A graphical user interface (GUI) 198 can display a workflow map as described earlier, and a workflow mapper can use information from the workflow versioning client 162 and the database 184 to generate the workflow map to be displayed on the GUI 198.

There are similarities between the parser plugin controller 164 of FIG. 11 and the relationship extractor 146 of FIGS. 8 and 9. Each can extract relationship information from explicit information contained in the file itself. This can be done in response to receiving file system events which can indicate when application processes have written a data file of interest, for example when Photoshop has written a “.psd” file.

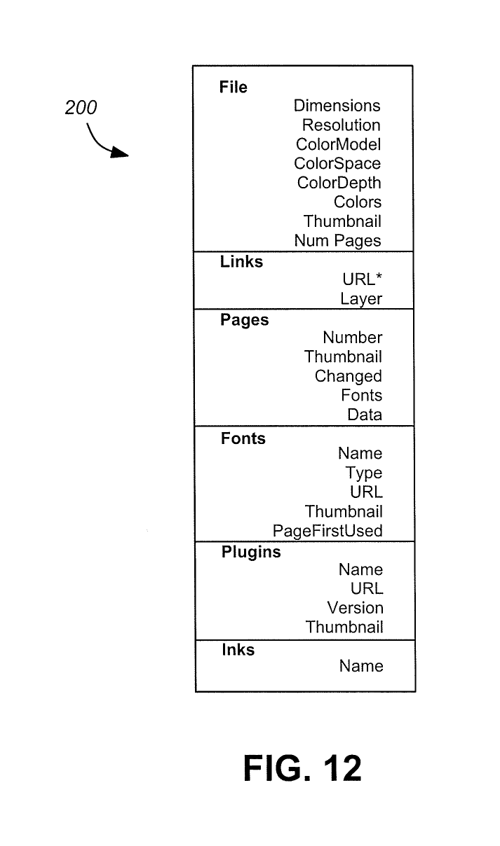

In an embodiment, when the user-space program receives file events that indicate that an application data file has been created or updated, it invokes a parser for the specific file format. A separate parser, or parser plugin 170, is preferably provided for each supported file format. For example, the desktop publishing application, Adobe InDesign writes to the file /SomeDirectoryPath/MyDesktopPublishingProject.indd. The suffix “.indd” is the file extension for InDesign Documents. In an embodiment, a parser for this format is provided to extract information such as shown in FIG. 12 by understanding the file format.

FIG. 12 illustrates an exemplary output 200 of a parser according to an embodiment of the present invention showing relationship information extracted based on file format understanding. In this example, once the parser recognizes that the document is an Adobe InDesign document, it determines that this file format has a number of properties, such as: File; Links; Pages; Fonts; Plugins; and Inks. Each of those properties has its own attributes, general examples of which are shown in FIG. 12. The indd format parser parses the indd document in order to extract the desired properties and attributes.

For instance, the parser recognizes that the InDesign document has a number of different attributes with respect to the File properties. Such attributes, as shown in FIG. 12, include the dimensions, resolution, color model, color space, color depth, colors, thumbnail, and number of pages. Regarding the File attributes: dimensions can be the horizontal and vertical dimensions of the file; resolution can be measured in points per inch (PPI); color model can be RGB, CMYK, etc.; color space can be Apple RGB, Adobe RGB, etc.; color depth can be expressed in bits, or another measure; color values used in the file can be extracted, as well as a thumbnail image representing the file.

The Links attributes in FIG. 12 represent externally referenced files. The URL is the uniform resource locator of the externally referenced files. The layer value contains an identification of the layer in which the link is used. In terms of pages, the page number and a thumbnail of that image can be extracted. A “changed” indicator can indicate if a page has changed as part of the last save, with a true/false value being an exemplary indicator. Information can be extracted regarding the fonts used and their attributes, such as italics, bold, underline, size, etc. Pages data can include copy layer data to the clipboard.

The Fonts attributes can include a name of a font used in the file, the type (TrueType, PostScript, etc.) and the URL of the named font. A thumbnail image of the font can also be extracted, as well as an indication of the page on which the font is first used. The Plugins attributes can include the name of the plugin used in the file, the URL and version of the named plugin, and a thumbnail image representing the plugin. The Inks attributes can include a name of ink(s) used.

For each file format of interest, the parser extracts information such as that described in relation to FIG. 12 for the InDesign format. A separate parser is preferably provided for each file format of interest, with the extracted relationship information being different based on the file format. Embodiments of the present invention provide for a configuration that allows the system to be extended to support new or modified application file formats.

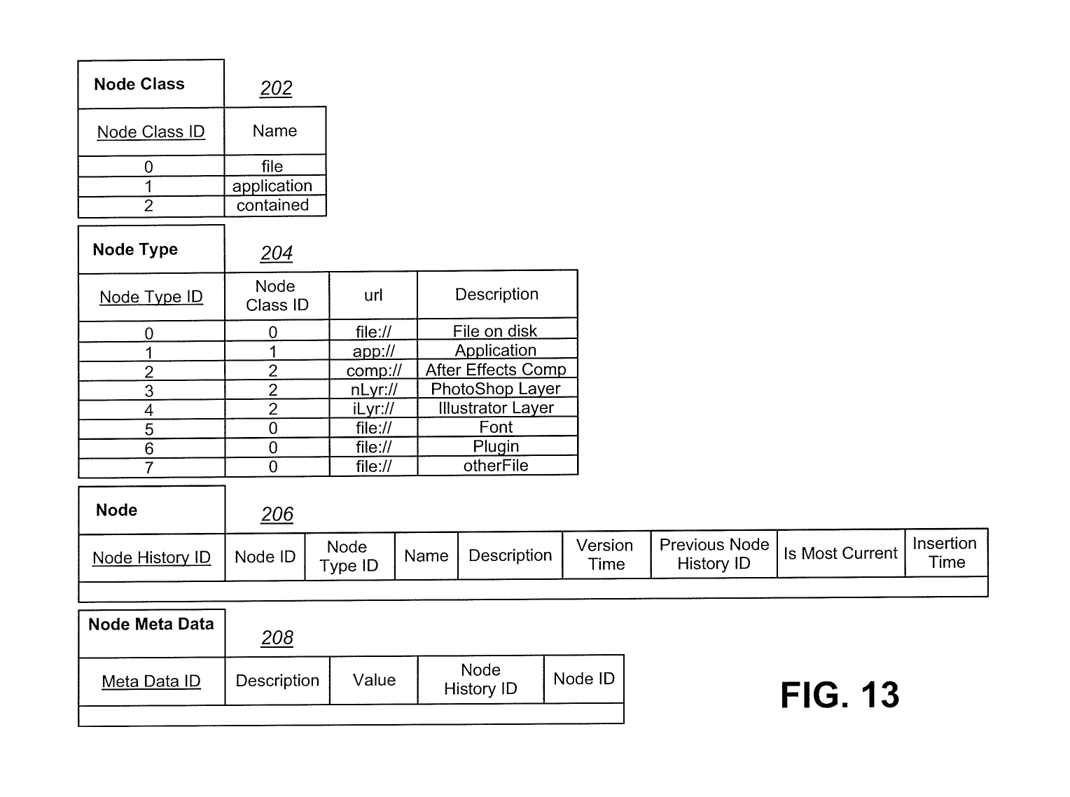

FIGS. 13-18 illustrate and describe a workflow database schema, and associated flowcharts, that can be used according to an embodiment of the present invention to model Nodes, Links and Graphs as well as allowing all entries to be versioned. The entries to be versioned can then be used to provide workflow versioning based, for example, on the file links and relationships.

To utilize the information extracted from data files according to any of the methods described above, an embodiment of the present invention includes a persistent database in which the information is organized and stored. In an embodiment, an efficient means of modeling this information is to represent each file as a Node and each relationship between two nodes as a Link. A link includes sufficient information to describe the relationship of the source node and the destination node between which the link is provided.

A named collection of Nodes and Links can be stored as a Graph, which has also been referred to herein as a workflow map. A Graph can be used to visualize a workflow and provide associated versioning information. Nodes, Links and Graphs can also have key/value pair based metadata associated with them.

FIG. 13 illustrates a first portion of a workflow database schema according to an embodiment of the present invention for workflow versioning. A node can be described in terms of node properties such as node class, node type, and other node characteristics. A node class table 202 is defined, in which the node can be identified as a file, and application, or a contained entity. A file can be a disk file, an image file, a font file, a plug-in file, etc. An application can be an application program used to edit/view files, e.g. Adobe Photoshop CS2. A contained entity can be an entity contained in another file, document or project, such as a layer in Adobe PhotoShop, a layer in Adobe Illustrator, or an Adobe AfterEffects composition.

A node type table 204 is shown in which the node type has a node type ID and a node class ID, along with a uniform resource locator (URL) and a description. Node class 0 refers to a file of one or more types. The file can be: a file on disk, such as project files and image files; a font; a plugin; or another file that is not a plugin, font or primary object file. Node class 1 refers to an application, such as PhotoShop, Illustrator, AfterEffects, InDesign, etc. Node class 2 includes three different types, including an AfterEffects composition, PhotoShop layer, or Illustrator layer. Of course, in other embodiments, the node class identifiers and type identifiers will vary both in number and in description, depending on the types of assets used in the workflow.

A node database entry 206 is shown in FIG. 13 that can include a node history ID, which is a unique numeric identifier for a node record, and a node ID. All versions of a node will share the node ID. For the initial version of a file, the node history ID=the node ID. A node type ID is a foreign key index into the NodeType table. A node Name is string name of the node. When the node is a file or a layer, the node name can be the name of the file or the layer, respectively. A node description is a string description of the node, which, for a file, can be a URL. A version time is a numeric field indicating a timestamp for this version, such as the number of seconds since 1970. A previous node history ID provides an indication of whether this is the most current version for the node ID, by providing the node history ID for the previous version of a node matching this node ID. An insertion time indicates the time at which the record was entered into the database, which can be controlled through an automatic trigger.

Node metadata 208 can be included in the database, including meta data ID, description, value, node history ID, and node ID. The metadata ID, description and value can be modified to represent any type of metadata of interest.

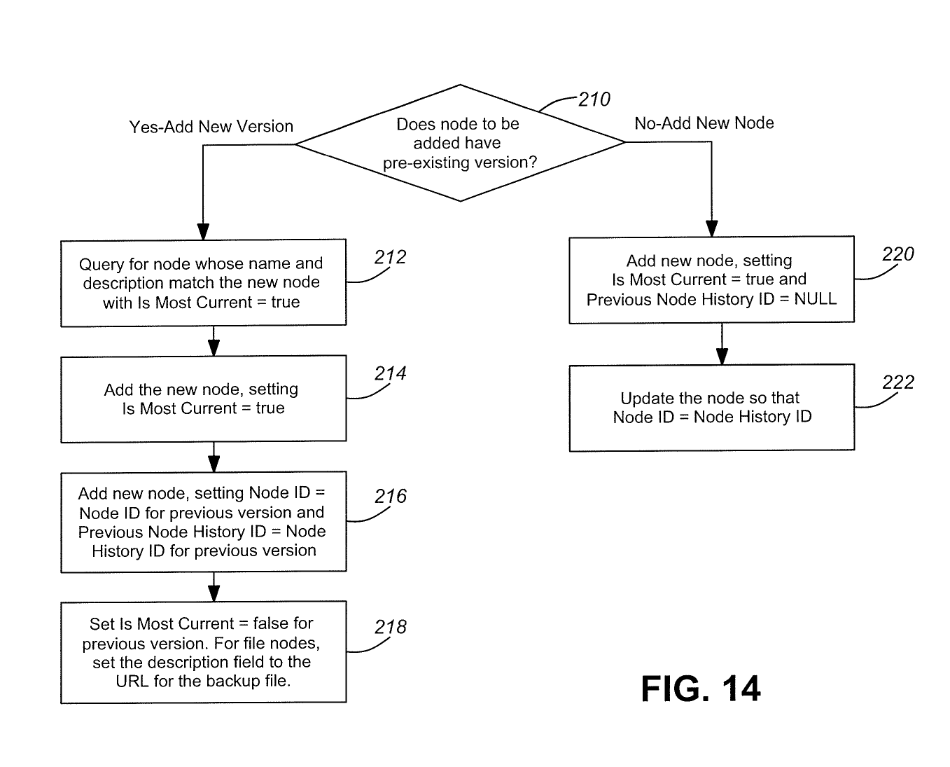

FIG. 14 is a flowchart illustrating steps in a method of adding a new node or node version according to an embodiment of the present invention. In step 210, a determination is made whether the node to be added has a pre-existing version. If yes, then a new version of an existing node is to be added as follows: query for a node whose name and description match the new node with IsMostCurrent=true (step 212); add the new node, setting IsMostCurrent=true (step 214); add the new node, setting NodeId=NodeId for previous version and PreviousNodeHistoryId=NodeHistoryId for previous version (step 216); set IsMostCurrent=false, and for previous version, for file nodes, set the Description field to the URL for the backup file (step 218)

If the determination is step 210 is no, then a new node is added with no preexisting version, and the following steps can be taken according to an embodiment of the present invention: add the new node, setting IsMostCurrent=true and PreviousNodeHistoryId=NULL (step 220); and update the node so that NodeId=NodeHistoryId (step 222).

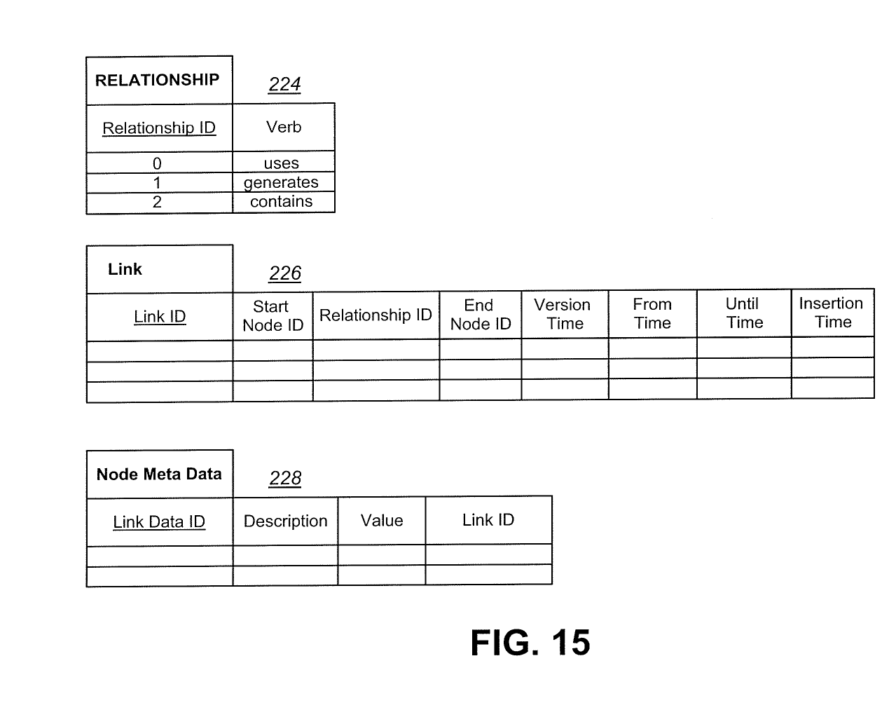

FIG. 15 illustrates a second portion of a workflow database schema according to an embodiment of the present invention for workflow versioning. Relationship data 224 can be provided, showing whether the node uses, generates, or contains another node with which a link has been established. The stored relationship type can be used, in part, to determine how the relationship will be visually represented in a workflow map or graph. Other relationship types can be provided based on the relationships that exist (or can exist) between the types of assets used in the workflow.

In this embodiment, relationships between nodes are represented by links. Link data 226 can be stored in a database according to an embodiment of the present invention. Each link can have a number of properties, including link ID, start node history ID, start node ID, relationship ID, end node ID, version time, from time, until time and insertion time. Link metadata 228 can include a link metadata ID, description, value and link ID. A particular embodiment with respect to link characteristics will now be described. A link can be defined by a startnode, relationship and endnode, where the relationship is a verb applied to startnode with respect to endnode. For instance, startNode uses endnode. The fields FromTime and UntilTime determine the timespan for which the link is valid. In most instances, these time values are the VersionTime for a particular version of startnode. When a new link is created, FromTime and UntilTime are both the same value. If a link is being updated because a new version of a startnode has been created then the UntilTime is updated to extend the time span for the link.

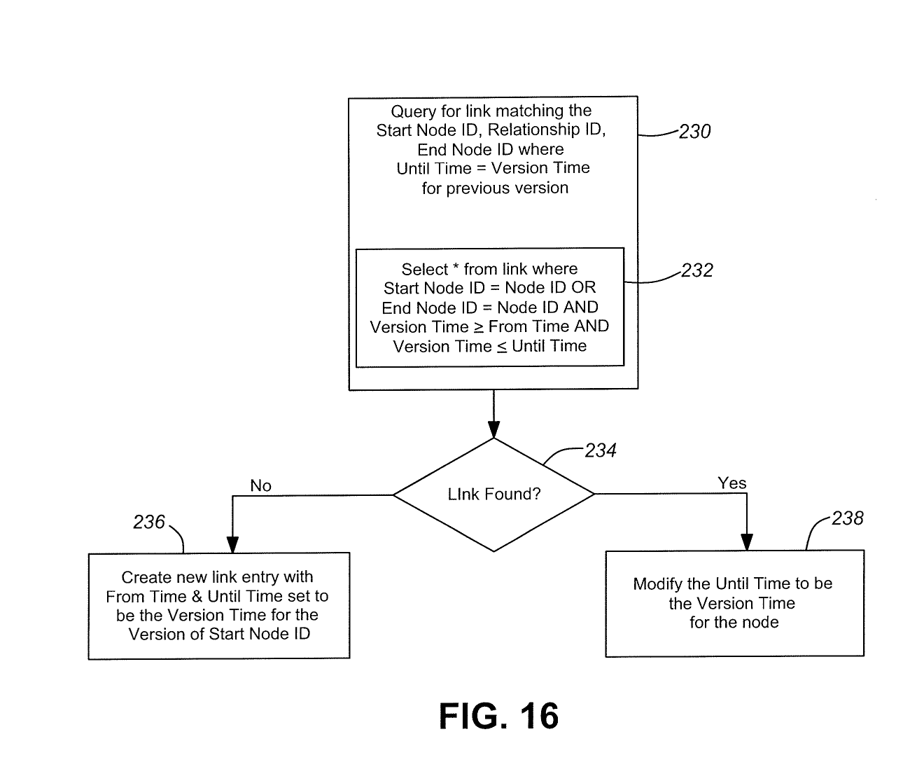

FIG. 16 is a flowchart illustrating steps in a method of adding a new link according to an embodiment of the present invention. In step 230, the method queries for a Link matching the StartNodeId, RelationshipId, EndNodeId where UntilTime=VersionTime for previous version. In step 232, to query for the links for a particular node version, select all values from Link where StartNodeId=NodeId OR EndNodeId=NodeId AND VersionTime >=FromTime AND VersionTime <=UntilTime. It is to be noted that the VersionTime is the VersionTime field from the Node. In step 234, a determination is made whether a link has been found in steps 230 and 232. For each link found, in step 238 the UntilTime is modified to be the VersionTime for the Node. If no link is found, in step 240 a new link entry is created with FromTime and UntilTime set to be the VersionTime for the Version of StartNodeId

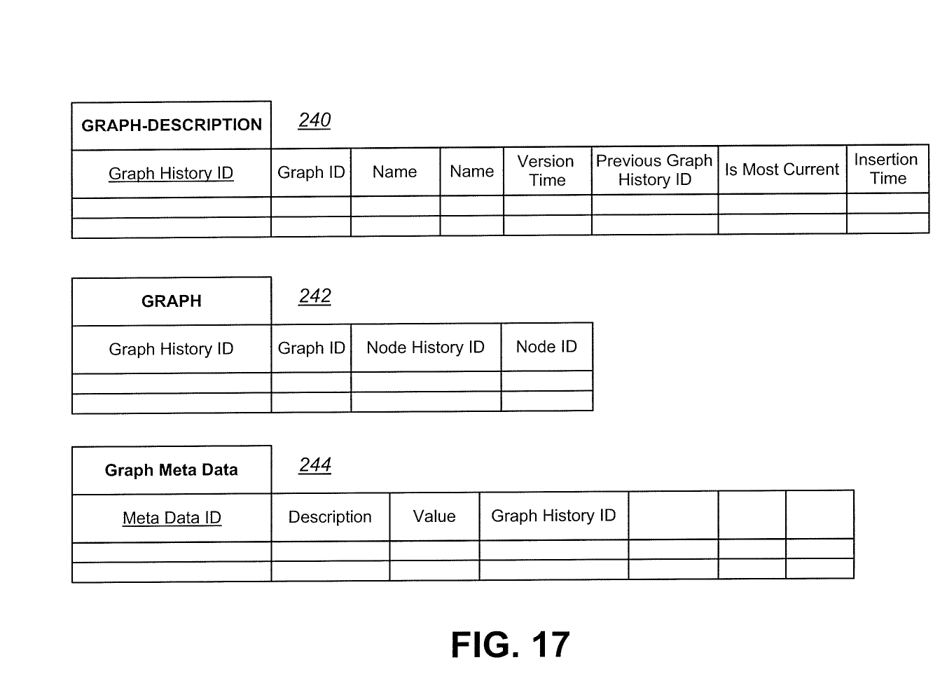

FIG. 17 illustrates a third portion of a workflow database schema according to an embodiment of the present invention for workflow versioning. This portion relates to a Graph, or workflow map, which was previously described as a named collection of Nodes and Links that can be used to visualize a workflow and provide associated versioning information. A graph description 240 can include a graph history ID, which is a unique numeric identifier for a graph description record. All versions of a graph share a graph ID. The initial version of a graph has a graph history ID=graph ID. A graph can have a name, which is typically a string naming the graph. A version time is a numeric field indicating a timestamp for this version, such as the number of seconds since 1970. A previous graph history ID provides an indication of whether this is the most current version for the graph ID, by providing the graph history ID for the previous version of a graph matching this graph ID. An insertion time indicates the time at which the record was entered into the database, which can be controlled through an automatic trigger.

As shown in graph data 242, a graph can be described by a graph history ID, a graph ID, a node history ID, and a node ID. Graph metadata 244 can include a metadata ID, a description, a value and a graph history ID.

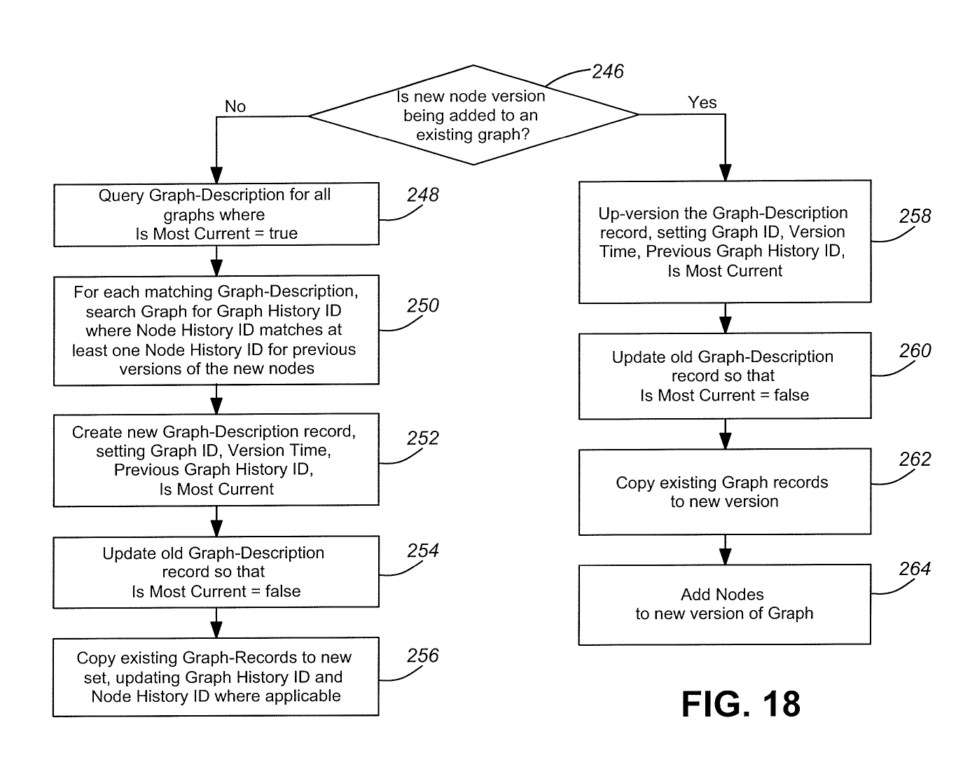

FIG. 18 is a flowchart illustrating steps in a method of up-versioning a graph according to an embodiment of the present invention when new node versions are added to a new or existing graph. In step 246, a determination is made as to whether the new node version is being added to an existing graph. If the determination is no, the method proceeds to execute steps for up-versioning a Graph when new node versions are added, as follows: query Graph-Description for all graphs where is MostCurrent=true (step 218); for each matching Graph-Description, search Graph for GraphHistoryId where NodeHistoryId matches at least one NodeHistoryId for previous versions of the new nodes (step 250); create new Graph-Description record, setting GraphId, VersionTime, PreviousGraphHistoryid, IsMostCurrent (step 252); update old Graph-Description record so that IsMostCurrent=false (step 254); and copy Existing Graph-Records to new set, updating Graph HistoryId and NodeHistoryId where applicable (step 256).

If the determination in step 246 is yes, then the method proceeds to execute steps for up-versioning a Graph when new nodes are added to an existing Graph, as follows: up-version the Graph-Description record, setting GraphId, VersionTime, PreviousGraphHistoryid, IsMostCurrent (step 258); update old Graph-Description record so that IsMostCurrent=false (step 260); copy existing Graph records to new version (step 262); and add Nodes to new version of Graph (step 264).

In view of the above description, a graph can be defined as a collection of Nodes where the GraphId and GraphHistoryId Match.

A method of automatic workflow versioning according to an embodiment of the present invention can include the following steps: detecting a workflow versioning event for a document; and upon detection of the workflow versioning event, updating a database entry and associated document relationships. This can be initiated upon detection of a file versioning event for a document, as described in co-pending United States Provisional patent application filed of even date herewith and entitled “Automatic File Versioning”, which is incorporated herein by reference.

An apparatus for automatic workflow versioning according to an embodiment of the present invention can include: a versioning detector to detect a workflow versioning event for a document saved to a database; a version creator, in communication with the versioning detector, to receive a notification of the workflow versioning event and to update the database accordingly. The system can also include a graph creator to create a graph based on node/document and link/relationship information stored in the database.

While embodiments of the present invention have been described above in relation to “documents”, it is to be understood that these approaches also apply to other types of files, assets or data entities stored on computers, or on computer-readable media. Such assets or data entities can include, for example: applications; files; folders; fonts; effects; image layers; animation compositions; video tracks; and audio tracks.

In the above description, for purposes of explanation, numerous details have been set forth in order to provide a thorough understanding of the present invention. However, it will be apparent to one skilled in the art that these specific details are not required in order to practice the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of automatic workflow versioning comprising:
detecting a workflow versioning event for a selected asset stored in memory in a computing environment, the selected asset being part of a set of assets associated with a workflow;
augmenting a workflow database with a new workflow version in response to the detected workflow versioning event;
updating a visual representation of the selected asset in a workflow map based on the new workflow version, the workflow map including the set of assets; and
displaying an updated workflow map of the set of assets, the updated workflow map including the updated visual representation of the selected asset.

2. The method of claim 1 wherein augmenting the workflow database comprises adding a new workflow version entry to an existing database entry for the selected asset based on information associated with the detected workflow versioning event.

3. The method of claim 1 wherein detecting the workflow versioning event comprises extracting updated logical relationship information for the selected asset.

4. The method of claim 3 wherein augmenting the workflow database comprises adding a new workflow version entry to an existing database entry for the selected asset based on the extracted updated logical relationship information.

5. The method of claim 1 wherein the step of augmenting the workflow database comprises adding a database entry for the new workflow version, the database entry including an identification of the set of assets and their logical relationships at the time of the new workflow version.

6. The method of claim 1 further comprising:
associating the asset with the workflow when the workflow versioning event is the first workflow versioning event for the asset as part of the workflow.

7. A computer-readable medium storing statements and instructions which, when executed, cause a processor to perform the steps of claim 1.

8. A system for automatic workflow versioning comprising:
a workflow database to store a workflow association associating a set of assets stored in memory in a computing environment with a workflow;
a workflow versioning event detector to detect a workflow versioning event for a selected asset from the set of assets;
a workflow version creator, in communication with the workflow versioning detector, to create a new workflow version in response to detection of the workflow versioning event and to augment the database based on the detected workflow versioning event; and
a workflow mapper to update a visual representation of the selected asset in a workflow map based on the updated database, and to display an updated workflow map of the set of assets, the updated workflow map including the updated visual representation of the selected asset.

9. The system of claim 8 further comprising a relationship extractor, in communication with the workflow database, to extract logical relationship information for the set of assets.

10. The system of claim 9 wherein the relationship extractor further comprises a file format detector to detect a file format of a selected asset, the relationship extractor to extract logical relationship attributes associated with the detected file format.

11. The system of claim 9 wherein the relationship extractor further comprises a file system event tracker to extract relationship information from a kernel extension in response to detection of a file system event that involves two different assets.

12. The system of claim 11 wherein the file system event is selected from the group consisting of: a copy action; a paste action; a save as action; a file move action; a file rename action; a file link action; a file delete action; a file open action; and a file close action.

13. The system of claim 9 wherein the workflow database associates the set of assets as part of the workflow even in the absence of a logical relationship between the set of assets.

14. The system of claim 9 wherein the workflow mapper displays a workflow map navigator including a navigation control to permit a user to navigate between workflow versions on a workflow timeline.

15. The system of claim 14 wherein, in response to navigation of the navigation control to a previous position on the workflow timeline, the workflow mapper displays a previous workflow map for the previous position, the previous workflow map displaying a subset of the plurality of assets having an earlier workflow association with one another at the previous position on the workflow timeline.

16. The system of claim 14 wherein the workflow mapper displays an activity indicator associated with the workflow timeline to visually indicate an amount of workflow activity associated with a particular portion of the timeline.

17. The system of claim 14 wherein the workflow mapper displays a version indicator associated with the timeline to visually indicate a time or version number associated with a particular version of the workflow.

18. The system of claim 9 wherein the workflow database, the workflow versioning event detector, the workflow version creator and the workflow mapper are provided independent of an application in which assets are generated.

19. A graphical user interface providing an ordered display of assets stored in memory in a computing system, the assets being part of a workflow, comprising:
a workflow map displaying a plurality of assets having a workflow association with one another at a particular time, the workflow association associating the plurality of assets as part of the workflow even in the absence of a logical relationship between the plurality of assets,
the workflow map concurrently displaying a visual indication of a logical relationship between a first asset and a second asset at the particular time, the first and second assets being part of the plurality of assets.

20. The graphical user interface of claim 19 wherein the workflow map further concurrently displays an additional logical workflow relationship between related assets in the plurality of assets, the additional logical workflow relationship being distinct from the logical workflow relationship.

21. The graphical user interface of claim 19 further comprising a workflow map navigator including a workflow timeline, the workflow map navigator indicating a position on the workflow timeline of a workflow version for which the workflow map is being displayed.

22. The graphical user interface of claim 21 wherein the workflow map navigator is movable to a previous position on the workflow timeline, in response to which the graphical user interface displays a previous workflow map for the previous position, the previous workflow map displaying a subset of the plurality of assets having an earlier workflow association with one another at the previous position on the workflow timeline.

23. The graphical user interface of claim 22 wherein the previous workflow map concurrently displays a further visual indication of a logical workflow relationship between a third asset and a fourth asset at the particular time, the first and second assets being part of the subset of the plurality of assets.

24. The graphical user interface of claim 21 wherein the workflow map navigator further comprises an activity indicator associated with the timeline to visually indicate an amount of workflow activity associated with a particular portion of the timeline.

25. The graphical user interface of claim 21 wherein the workflow map navigator further comprises a version indicator associated with the timeline to visually indicate a time associated with a particular version of the workflow.

26. The graphical user interface of claim 19 wherein the workflow association associates the plurality of assets as part of the workflow even in the absence of a logical usage relationship between the plurality of assets.

27. A graphical user interface providing an ordered display of assets stored in memory in a computing system, the assets being part of a workflow, comprising:
a workflow map displaying a plurality of assets having a workflow association with one another at a particular time, the workflow association associating the plurality of assets as part of the workflow even in the absence of a logical relationship between the plurality of assets.
